(19) United States
(12) Patent Application Publication
(10) Pub. No.: US 2014/0004948 A1
(43) Pub. Date: Jan. 2, 2014

(54) Systems and Method for Capture and Use of Player Emotive State in Gameplay

(71) Applicants: Oliver (Lake) Watkins, JR., Toronto (CA); Yousuf Chowdhary, Maple (CA); Jeffrey Brunet, Richmond Hill (CA); Ravinder ("Ray") Sharma, Richmond Hill (CA)

(72) Inventors: Oliver (Lake) Watkins, JR., Toronto (CA); Yousuf Chowdhary, Maple (CA); Jeffrey Brunet, Richmond Hill (CA); Ravinder ("Ray") Sharma, Richmond Hill (CA)

(21) Appl. No.: 13/930,027

(22) Filed: Jun. 28, 2013

Related U.S. Application Data
(60) Provisional application No. 61/690,493, filed on Jun. 28, 2012.

(51) Int. Cl. A63F 13/06

(52) U.S. Cl. CPC A63F 13/06
USPC 463/36

(57) ABSTRACT

A computer-implemented method is provided that enables virtual gameplay with a character on a computing device. Access is provided to at least one video game in which a player is able to interact via a character. The player's emotive state is detected and stored. In response to the detected emotive state, the computing device retrieves a storyline for the character that is related to the emotive state of the player.

### CROSS-REFERENCE TO RELATED APPLICATIONS

This application claims the benefit of earlier filed U.S. Provisional Application No. 61/690,493, filed on Jun. 28, 2012, which is incorporated by reference herein in its entirety.

### FIELD OF INVENTION

The present invention is related to capturing the player emotive state and using this to impact the gameplay of virtual worlds.

### BACKGROUND OF THE INVENTION

A virtual world is a computer simulated environment. A virtual world may resemble the real world, with real world rules such as physical rules of gravity, geography, topography, and locomotion. A virtual world may also incorporate rules for social and economic interactions between virtual characters. Player (users) may be represented as avatars, two or three-dimensional graphical representations. Virtual worlds may be used for massively multiple online role-playing games, for social or business networking, or for participation in imaginary social universes.

Prior art virtual worlds have storylines that are either static or branch in a rather predictable fashion. Prior art methods for a branching storyline are well known in the industry, where the outcome of one encounter defines the starting point of the next. Such virtual worlds have a set number of possible branches and a player's skills, interaction with other players and non-player characters (NPCs) aid in the creation of variety and new possibilities. Mostly the storyline is also dependent on the virtual character (Player Character) that a player chooses to engage in the gameplay of the virtual world.

Above described prior art lack the ability to take the player's emotive state into account for meaningful impact on the gameplay. Our invention overcomes these limitations of the prior art and provides methods and systems that offer a richer and more unique gameplay experience for each player.

### SUMMARY OF THE INVENTION

This application describes a system and method to capture player emotive state and using that emotive state information to impact the gameplay of a virtual world.

A player's emotive state e.g. whether the player is happy, angry, sad, frustrated may have a significant meaning for the player. By determining the emotive state of a player engaged in the gameplay of a virtual world and impacting the storyline of a virtual world based on the emotive state of the player a more interesting and meaningful experience can be provided. Thus a player may be willing to spend more time engaging with a virtual world when the said virtual world's storyline is impacted by how the player feels.

This application describes systems and methods whereby the storyline of a virtual world may change based on the real world emotions of a player. Thus real emotive state of the player can influence the gameplay of a virtual world.

In one embodiment of the invention increase or decrease the level of difficulty of the gameplay or alter the gameplay depending on the captured player emotive state. For example if the player is too happy change the gameplay to make it harder, while if a player is frustrated change the gameplay to make it easier to play the game.

The system of invention uses available sensors to capture the player emotive state while playing a game. For example the method of the invention may use any one or any combination of different sensors to gather the player emotive state; e.g. a camera can sense the player's facial expressions, a microphone can pick the grunting noises being made by the player, special materials can pick the temperature and blood flow of skin as the player's hands or other body parts that come into contact with the game controller, or the device on which the game is being played.

Already many devices exist that are used for gaming and incorporate different sensors which can provide information that can be used to decipher the player's emotive state. For example an embedded video capture sensor (camera) can provide information about the player's facial expression, an audio capture sensor (microphone) and sensors like accelerometer and gyroscope built in it, and may include but not limited to an iPhone, iPad, Smartphones, Android phones, personal computers e.g. laptops, tablet computers, touchscreen computers, gaming consoles and online server based games.

The term storyline may include but not limited to the aesthetics, virtual characters that are available, plot, set of plot nodes, settings etc. and may change individually or in combination with the emotive state of the player.

Storyline can change, evolve, branch or morph based on the emotive state of the player. Alternate settings may be applied, alternate levels may be offered for gameplay based on the emotive state the player. In one embodiment of the invention, the items and loot that the players may come across, monsters and enemies that they may fight, traps and puzzles that they may have to overcome may vary based on a player's emotive state.

According to a first aspect of the invention, a computer-implemented method is provided for enabling virtual gameplay with a character. Access is provided to at least one video game (on a computing device in communication with a storage means) in which a player is able to interact with the video game via a character. The player's emotive state is detected at the computing device, and stored on the storage means. In response to the detected emotive state, a storyline is retrieved for the character to interact with (using the computing device). This retrieved storyline is related to the emotive state of the player.

Second or subsequent emotive states of the player may also be detected in the course of gameplay, and second or further storylines retrieved for the player's character to interact with (i.e. related to the second or subsequent emotive state). The second or further storyline may replace or be added to the previously retrieved storyline.

Each storyline preferably includes one or a combination of plot, plot nodes, character interactions, encounters, settings, aesthetics, levels, premise, or theme.

The level of difficulty may be modified in response to the detected emotive state. For example, a detected happy or content emotive state may result in an increased level of difficulty. A detected sad, angry or frustrated emotive state may result in a decreased level of difficulty.

The character may also be changed to match the player's emotive state. Some examples of changes include modifying the character's appearance, facial or body expression or health in response to the detected emotive state. The character may also be changed to be the reverse of the player's emotive state. The character statistics of the character may be changed in response to the detected emotive state. The tools, equipment or clothing of the character in response to the detected emotive state.

The scene or setting may also be modified to reflect the player's emotive state. Further, objects in the game and non-player characters may be changed. For example, game monsters, enemies, traps or puzzles may be modified in response to the player's emotive state.

In one embodiment, the video game is accessible by multiple players and players having the same emotive state can interact in the game with each other via their characters. In the game, each player's emotive state is detected. When a new player joins the game, and the player has a previously-unrepresented emotive state, this opens up a new storyline for all of the players currently in the game. Likewise, if a player is the only player having a specific emotive state, the departure of that player from the game may close up that storyline for the remaining players in the game.

The player's emotive state may be detected once (at login or during gameplay, as described), or it may be re-detected at intervals. In the event of a change in the player's emotive state, the character may be shown moving to a new scene in the storyline.

The detecting may include matching a player's facial or body expression to facial and body expressions in a database of emotive states. Likewise, the detecting step may include matching a player sound or vocalization to sounds and vocalizations in a database of emotive states.

If a neutral emotive state is detected or the detected emotive state is an unsupported emotive state, a default storyline may be provided.

The storage means may be provided by one or a combination of: a local fixed memory, a local removable memory, a remote fixed memory, a remote removable memory, and a virtual memory. It may be selected from the group consisting of: a local data storage of a game console, a local inbuilt memory, a user provided memory, an online server, and a shared folder on a network. The storage of the data need not be long-term storage, but may be temporary (or for immediate use only), including cache-type storage.

The detecting may be done by retrieving emotive state data from a sensor. For example, where the player is enabled to play the game using a game device (e.g. a mobile device), the player's emotive state may be detected by an on-board sensor on the game device.

The sensor may be one or a combination of camera, video camera, microphone, accelerometer, gyroscope, touch screen, temperature sensor, or pressure sensor. Preferably, the sensor is a sensor that is not otherwise used as a game controller. Preferably, any sensor used as a game controller is not used to receive player emotive state.

Emotive state information can also be retrieved from or validated with player input.

Preferably, the player's emotive state is compared to emotive states in a database. The emotive states database may be pre-populated. The database may also be customizable with player input (such as to allow the player to define what their personal “happy face” looks like).

### BRIEF DESCRIPTION OF THE FIGURES

FIG. 1 is a flow diagram illustrating the primary steps of the method, according to a preferred embodiment.

FIG. 2 is a flow diagram representing an example of sensor detection of an emotive state and mapping to known emotive states in a database.

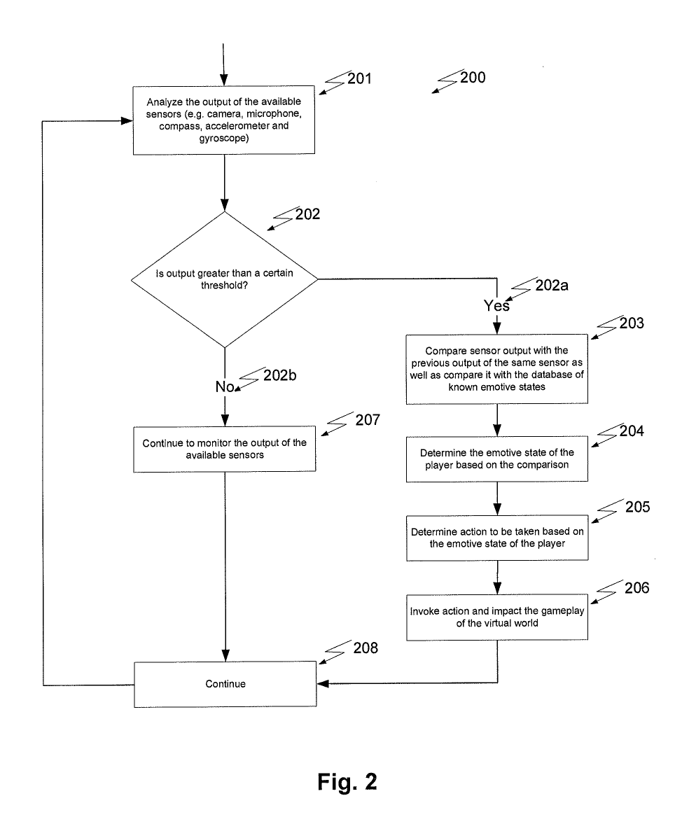

FIG. 3 is a conceptual diagram illustrating the interplay between multiple sensors and aspects of the storyline in a virtual world.

FIG. 4 is a flow diagram representing an example of representing an example of ongoing facial/body expression detection.

FIG. 5 is a flow diagram representing an example of how emotive state may be used in a MMORPG context to open certain plot nodes.

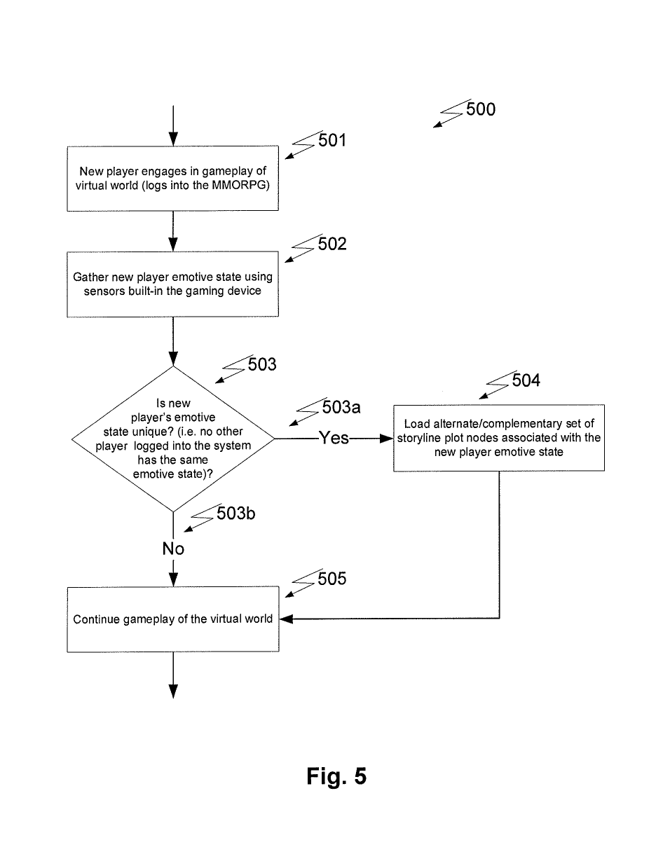

FIG. 6 is a flow diagram representing an example of how emotive state may be used in a MMORPG context to close certain plot nodes.

FIG. 7 is a conceptual diagram of a simple embodiment of the invention, in this case using a mobile device camera to detect facial expressions.

### DETAILED DESCRIPTION

Methods and arrangements for capturing and using player emotive state and using this to impact the virtual worlds or their gameplay are disclosed in this application.

Before embodiments of the invention are explained in detail, it is to be understood that the invention is not limited in its application to the details of the examples set forth in the following descriptions or illustrated drawings. The invention is capable of other embodiments and of being practiced or carried out for a variety of applications and in various ways. Also, it is to be understood that the phraseology and terminology used herein is for the purpose of description and should not be regarded as limiting.

Before embodiments of the software modules or flow charts are described in detail, it should be noted that the invention is not limited to any particular software language described or implied in the figures and that a variety of alternative software languages may be used for implementation of the invention.

It should also be understood that many components and items are illustrated and described as if they were hardware elements, as is common practice within the art. However, one of ordinary skill in the art, and based on a reading of this detailed description, would understand that, in at least one embodiment, the components comprised in the method and tool are actually implemented in software.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A “virtual world” as used herein need not be a “game” in the traditional sense of a competition in which a winner and/or loser is determined, but rather that the term “game” incorporates the idea of a virtual world. Moreover, a person or entity who enters the virtual world in order to conduct business, tour the virtual world, or simply interact with others or the virtual environment, with or without competing against another person or entity is still considered to be “playing a game” or engaging in the gameplay of the game.

Virtual worlds can exist on game consoles for example Microsoft Xbox, and Sony Playstation, Nintendo Wii, etc., or on online servers, or on mobile devices (e.g. an iPhone or an iPad), Smartphones, portable game consoles like the Nintendo 3DS, or on a PC (personal computer) running MS Windows, or MacOS, Linux, Google Android or another operating system. This list is not exhaustive but is exemplary of devices or computing environments where virtual worlds can exist, many other variations are available and known to the ones skilled in the art.

A computer or a game console that enables a user to engage with a virtual world, including a memory for storing a control program and data, and a processor (CPU) for executing the control program and for managing the data, which includes user data resident in the memory including a set of gameplay statistics. The computer, or a game console, may be coupled to a video display such as a television, monitor, or other type of visual display while other devices may have it incorporated in them (iPad). A game or other simulations may be stored on a storage media such as a DVD, a CD, flash memory, USB memory or other type of memory media. The storage media can be inserted to the console where it is read. The console can then read program instructions stored on the storage media and present a game interface to the user.

The term “player” is intended to describe any entity that accesses the virtual world, regardless of whether or not the player intends to or is capable of competing against other players. Typically, a player will register an account with the game console within a peer-to-peer game and may choose from a list or create virtual characters that can interact with other virtual characters of the virtual world.

The term “engage in gameplay” generally implies playing a game whether it is for the purpose of competing, beating, or engaging with other players. It also means to enter a virtual world in order to conduct business, tour a virtual world, or simply interact with others or a virtual environment, with or without competing against another entity.

Typically, a user or a player manipulates a game controller to generate commands to control and interact with the virtual world. The game controller may include conventional controls, for example, control input devices such as joysticks, buttons and the like. Using the controller a user can interact with the game, such as by using buttons, joysticks, and movements of the controller and the like. This interaction or command may be detected and captured in the game console. The user's inputs can be saved, along with the game data to record the game play.

Another method to interact with a virtual world is using the touch screen for interaction with the virtual world. A gesture refers to a motion used to interact with multipoint touch screen interfaces. Multi-touch devices employ gestures to perform various actions.

A virtual object may comprise any one of a virtual character of an online game, an virtual good of an online game, a weapon of an online game, a vehicle of an online game, virtual currency of an online game, experience points of an online game and permissions of an online game etc. A virtual object may further be any item that exists only in a virtual world (game).

A virtual object may include virtual money, experience points, weapons, vehicles, credentials, permissions and virtual gold. A player's online persona may obtain these virtual objects via game-play, purchase or other mechanisms. For example, as a player of a first person shooter completes various levels of the game, he obtains additional weapons, armour, outfits, experience points and permissions. Additional weapons and armour which may be beneficial in facilitating the completion of levels and allow the player to perform in new and different ways may be acquired (i.e. purchased). Additional permissions may unlock additional levels of the game or provide access to an otherwise hidden forum or stage. Whatever the items, players are constantly in search of virtual objects so as to enrich their game experience.

A virtual object may be defined by its function and form. The functional component of a virtual object describes its functional properties such as whether it is a weapon, whether it can be worn, where it can be worn, how heavy it is, and what special powers it has. In contrast, the form component of a virtual object describes the look, feel, and sound that are its characteristics. Virtual object can have some function within their virtual world, or can be solely used for aesthetic purposes, or can be both functional and decorative. The virtual character can be considered a special kind of a virtual object; it has a function, as well as a form and it represents a player and may also be controlled by the player.

A virtual character may include a persona created by a player or chosen from a list in the virtual world. Typically virtual characters are modeled after humans whether living or fantasy (e.g. characters from mythology).

A virtual character (can be considered a special virtual object) is represented by one or more gameplay statistics, which encapsulate some meaning to connect the virtual (and digital) reality of the game to the real world. Many of these statistics are not apparent to the player as such, but are instead encoded within the framework of the game or composed together to form a script. In role-playing games (RPGs) and similar games, these statistics may be explicitly exposed to the player through a special interface, often with added meaning which provides context for the player's actions.

A statistic (stat) in role-playing games (RPG) is a datum which represents a particular aspect of a virtual character. Most virtual worlds separate statistics into several categories. The set of categories actually used in a game system, as well as the precise statistics within each category may vary greatly from one virtual world to another. Many virtual worlds also use derived statistics whose values depend on other statistics, which are known as primary or basic statistics. Derived statistics often represent a single capability of the character such as the weight a character can lift, or the speed at which they can move. Derived statistics are often used during combat, can be unitless numbers, or may use real-world units of measurement such as kilograms or meters per second.

A virtual character's statistics affects how it behaves in a virtual world. For example, a well-built muscular virtual character may be more powerful and be able to throw certain virtual objects farther, but at the same time may lack dexterity when maneuvering intricate virtual objects. A virtual character may have any combination of statistics, but these statistics may be limited by either hard counters, soft counters or a combination of both.

Primary Statistics represent assigned, abstract qualities of a virtual character, such as Strength, Intelligence, and so on. Partially defined by convention and partially defined by context, the value of a primary statistic corresponds to a few direct in-game advantages or disadvantages, although a higher statistic is usually better. In this sense, primary statistics can only really be used for direct comparison or when determining indirect advantages and disadvantages.

Derived Statistics represent measured, concrete qualities of a virtual character, such as maximum carry weight, perceptiveness, or skill with a weapon. Such a stat is derived from some function of one or more of a character's primary stats, usually addition or multiplication. These stats then serve an important function in turn, providing a fair means by which to arbitrate conflicts between virtual characters and the virtual environment. For example, when two virtual characters are in violent conflict, Strength, a primary statistic, might be used to calculate damage, a derived statistic, with the winner being the character that inflicts the most damage on the other.

For the purpose of this application the term “gameplay statistics” refers to any one or any combination of gameplay frequency, gameplay time, number of times game played, percent game complete etc. as result of engaging in gameplay.

An avatar may include the physical embodiment of a virtual character in the virtual world.

In virtual worlds (video/computer games) a non-player character (NPC) is a virtual character that is controlled by the program and not a player. NPC may also refer to other entities not under the direct control of players. NPC behaviour in a virtual world may be scripted and automatic.

A player character or playable character (PC) is a virtual character in a virtual world that is controlled or controllable by a player. A player character is a persona of the player who controls it. In some cases a virtual world has only one player character and in other cases there may be a small number of player characters from which a player may pick a certain virtual character that may suit his or her style of gameplay, while in other scenarios there may be a large number of customizable player characters available from which a player may choose a virtual character of their liking. An avatar—may include the physical embodiment of a virtual character in the virtual world.

Virtual objects in a virtual world interact with the player, the virtual environment, and each other. This interaction is generally governed by a physics engine which enables realism in modeling physical rules of the real world (or arbitrary fantasy worlds). A physics engine is a computer program that, using variables such as mass, force, velocity, friction and wind resistance may simulate and predict effects under different conditions that would approximate what happens in either the real world or a fantasy world. A physics engine can be used by other software programs for example games or animation software to enhance the way virtual objects imitate the real world to produce games and animations that are highly realistic or to create dream-world effects.

Health is a game mechanic used in virtual worlds to give a value to virtual characters, enemies, NPCs, (non player characters) and related virtual objects. Health is often abbreviated by HP which may stand for health points or hit points; it is also synonymous with damage points or heart points. In virtual worlds health is a finite value that can either be numerical, semi-numerical as in hit/health points, or arbitrary as in a life bar, and is used to determine how much damage (usually in terms of physical injury) a virtual character can withstand when said virtual character is attacked, or sustains a fall. The total damage dealt (which is also represented by a point value) is subtracted from the virtual character's current HP. Once the virtual character's HP reaches 0 (zero), the virtual character is usually unable to continue to fight or carry forward the virtual world's mission.

A typical life bar is a horizontal rectangle which may begin full of colour. As the virtual character is attacked and sustains damage or mistakes are made, health is reduced and the coloured area gradually reduces or changes colour, typically from green to red. At some point the life bar changes colour completely or looses colour, at this point the virtual character is usually considered dead.

At the start of a typical game, the virtual character may have 10 health and be surrounded by numerous enemies. Each enemy applies an attack influence (a force toward the enemy) and a flee influence (a force away from the enemy) to the virtual character. Given these circumstances, the attack influence would carry the strongest priority, and so we would expect the virtual character to move toward the closest enemy (since influence is inversely proportional to distance).

Mobile devices including connected and unconnected devices are becoming the primary devices for playing games and keeping in touch. Such devices tend to be small, have limited processing and storage capacity and are usually powered by a re-chargeable battery. Although the main examples used in this application use a mobile device as an example, it is clear that the invention can also be used with significant advantages on other computing devices e.g. a computer that may be connected to one or more cameras and a microphone.

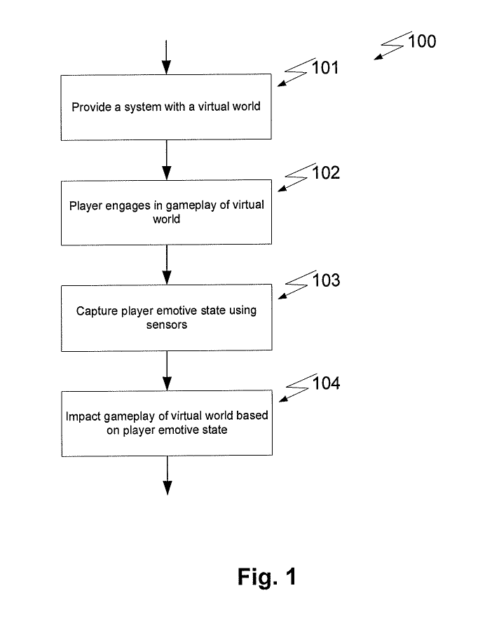

According to one embodiment of the invention, FIG. 1 shows the main principle of the invention.

According to one embodiment of the invention, a computer-implemented method is provided that enables virtual gameplay with a character on a computing device. Access is provided to at least one video game in which a player is able to interact via a character. The player's emotive state is detected and stored. In response to the detected emotive state, the computing device retrieves a storyline for the character that is related to the emotive state of the player.

As shown in FIG. 1 (a flow diagram highlighting at a conceptual level certain aspects of the method), a system is first provided that allows access to a virtual world 101. The virtual world may be a single player game or a multiplayer game or a MMORPG (Massively Multiplayer Online Role Playing Game) and may exist on any type of a gaming device which may include but not limited to an iPhone, iPad, Smartphones, Android phones, personal computers e.g. laptops, gaming consoles like Nintendo Wii, Nintendo DS, Sony PlayStation, Microsoft Xbox 360, and online server based games etc.

The computer program comprises: a computer usable medium having computer usable program code, the computer usable program code comprises: computer usable program code for enabling change in storyline based on the emotive state of a player, computer usable program code for presenting graphically to the player the different options available to modify and personalize different aspects of the virtual world including but not limited to settings.

In the virtual world that has been provided, the player engages in gameplay 102. As mentioned earlier, the term “engage in gameplay” generally implies playing a game whether it is for the purpose of competing, beating, or engaging with other players. It also means to enter a virtual world in order to conduct business, tour a virtual world, or simply interact with others or a virtual environment, with or without competing against another entity.

A virtual world that incorporates the invention, either in its entirety or some components of it, may be a single player game or a multiplayer game or a MMORPG (Massively Multiplayer Online Role Playing Game) and may exist on any type of a gaming device which provides a either a video capture sensor (camera) and sensors like accelerometer and gyroscope built in it, and may include but not limited to an iPhone, iPad, Smartphones, Android phones, personal computers e.g. laptops, tablet computers, touchscreen computers, gaming consoles and online server based games.

Prior to or during gameplay, the emotive state of the player can be captured using output from the sensors 103. As technology advances, more and more miniaturized electronic components become cost effective to be mass produced and included in all sorts of devices. Today many types of mobile devices e.g. Smartphones like iPhone include built-in cameras (front facing as well as rear facing), microphones, accelerometers, gyroscopes, and GPS sensors. Such devices also have data coverage via mobile cellular network or WiFi, and are widely used for engaging in the gameplay of virtual worlds. Thus determining the player emotive state with some accuracy using one or more of the embedded sensors has become possible.

### Sensors

Micro-Electro-Mechanical Systems (MEMS) is the integration of mechanical elements, sensors, actuators, and electronics on a common silicon substrate through microfabrication technology. In essence MEMS are tiny mechanical devices that are built onto semiconductor chips and are measured in micrometers. While the electronics are fabricated using integrated circuit process sequences the micromechanical components are fabricated using compatible “micromachining” processes. Complete systems-on-a-chip MEMS are an enabling technology allowing the development of smart products, augmenting the computational ability of microelectronics with the perception and control capabilities of microsensors and microactuators. Various sensors available on mobile devices are briefly discussed below.

### Video Capture Device (Camera)

A video capture device e.g. a camera can be used to capture the video or still image of the player and using the image to decipher the player emotive state.

### Audio Capture Device (Microphone)

An audio capture device e.g. a microphone can be used to capture vocal expressions of the player and using these audio to decipher the player emotive state.

### Digital Compass

An electro-magnetic device that detects the magnitude and direction of the earth's magnetic field and point to the earth's magnetic north. Used to determine initial state (players facing each other), and then to determine ground-plane orientation during play.

### Accelerometer

Used for corroborating the compass when possible, and for determining the up-down plane orientation during play. In an AR game compass and accelerometer provide directionality.

### Gyroscope

A gyroscope is a device for measuring or maintaining orientation, based on the principles of conservation of angular momentum. Gyroscopes can be mechanical or based on other operating principles, such as the electronic, microchip-packaged MEMS gyroscope devices found in consumer electronic devices. Gyroscopes include navigation when magnetic compasses do not work, or for the stabilization, or to maintain direction.

### Temperature Sensor

Temperature sensors tend to measure heat. There are two main types: contact and noncontact temperature sensors. Contact sensors include thermocouples and thermistors that touch the object they are to measure, and noncontact sensors measure the thermal radiation a heat source releases to determine its temperature. The latter group measures temperature from a distance.

### Pressure Sensor

A pressure sensor measures pressure. Pressure is an expression of the force applied to an area and is usually stated in terms of force per unit area. A pressure sensor usually acts as a transducer and it generates a signal as a function of the pressure imposed.

This detected emotive state can then be used to impact gameplay of the virtual world 104. Several exemplary methods of storyline change based on player emotive state are provided in this application.

The computer program comprises: a computer usable medium having computer usable program code, the computer usable program code comprises: computer usable program code for presenting graphically to the player the different options available to engage in gameplay via the touchscreen interface.

As mentioned earlier, the term “engage in gameplay” generally implies playing a game whether it is for the purpose of competing, beating, or engaging with other players. It also means to enter a virtual world in order to conduct business, tour a virtual world, or simply interact with others or a virtual environment, with or without competing against another entity.

Several implementation possibilities exist. Some obvious ones are listed below, but there may be other methods obvious to the ones skilled in the art, and the intent is to cover all such scenarios. The application is not limited to the cited examples, but the intent is to cover all such areas that may be used in a virtual world or other applications.

A definable threshold may be useful to define in order to differentiate between intended motions caused by the user from those that may be un-intended and caused by the normal movement of the user for example shaky hands. Thresholds may be dependent on the operating context. Operating context refers to internal and/or external factors impacting a particular system, device, application, business, organization etc. For example operating context for an application is the external environment that influences its operation. For a mobile application, the operating context may be defined by the hardware and software environment in the device, the target user, and other constraints imposed by various other stakeholders.

In one embodiment of the invention the output of the available sensors (e.g. camera, microphone, compass, accelerometer, gyroscope, etc.) may be analyzed 201. If the output of the sensor is greater than a certain threshold 202, the method continues on with the analysis. If the output of the sensor is less than the threshold 202b, the method simply continues to monitor the sensor output until a threshold-surpassing output is detected 208.

If the output of the sensor is greater than the threshold 202a, then the method compares the sensor output with the previous output of the same sensor, as well as with a database of known emotive states 203. The database may have different emotive states stored in it for comparison, e.g. a loud excited shout may be defined as a happy state while a frowny face may be associated with an angry/upset/frustrated emotive state. The database of emotive states may be pre-populated and may also be updated based on the individual player. In one embodiment of the invention this database may be edited/augmented by player(s); in so doing, a player may choose from a list of emotions and associate certain facial expressions and/or sounds to each emotion. The player may record photos of facial expressions and/or sounds (vocal expressions) of themselves when editing/augmenting this database to personalize it.

In one embodiment of the invention this database may be online and the games may access it as needed to determine the player emotive state. In another embodiment of the invention this database may be embedded in the game itself and the player emotive state is locally deciphered.

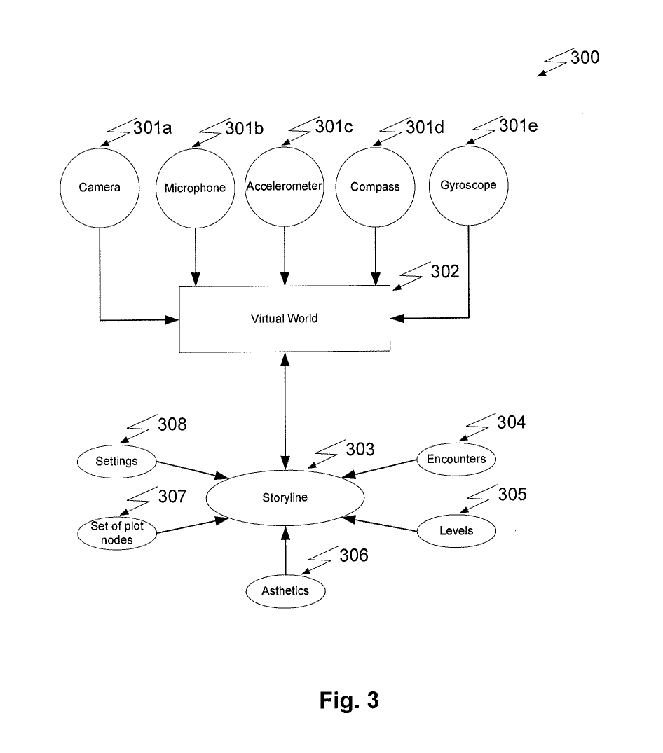

FIG. 3 above shows a conceptual view 300 where the various sensors e.g. camera 301a, microphone 301b, accelerometer 301c, compass 301d and gyroscope 301e are used for gathering the input from the player to determine the player emotive state.

The storyline 303 may be impacted/changed by a change in any one of the encounters 304, levels 305, aesthetics 306, set of plot nodes 307 and/or settings 308 (without limitation) based on the emotive state of the player(s) engaged in the gameplay. The storyline 303 then in turn impacts the gameplay of the virtual world 302.

For the purpose of this application the term “story” may mean storyline, plot nodes, virtual character(s), set of virtual characters or character interaction, encounters, settings, aesthetics, levels, premise or theme amongst other things. The intent is to cover all such areas that may be impacted by the emotive state of the player, and are known to the ones skilled in the art. Some of these terms are explained in more detail below.

### Plot

A plot defines the events a story comprises, particularly as they relate to one another in a pattern, a sequence, through cause and effect, or by coincidence. A well thought through plot with many different patterns of events results in a more engaging and interesting game. A plot may have a beginning, a middle, and an end, and the events of the plot may causally relate to one another as being either dependant or probable. A plot may also refer to the storyline or the way a game progresses. Similarly a storyline may refer to a plot or a subplot of a virtual world. Thus for the purpose of this application the terms plot and storyline may be used interchangeably.

### Plot Node

In a virtual world a plot node may be defined as a forking point in the storyline where the plot of the story can diverge based on the decisions a player makes, or the emotive state of the player.

### Plotline—Set of Plot Nodes

Plotline can be considered a certain sequence of interconnected plot nodes, while a set of plot nodes may or may not be interconnected. A plotline may be integral to the main storyline or may be complimentary and thus provide extra possibilities in terms of virtual character interaction and emotion-specific scenarios. Thus there may be a certain association between a certain player emotive state and a plotline or a certain set of plot nodes. Therefore when a certain player emotive state is determined the gameplay, the plotline or set of plot nodes associated with this emotive state may become incorporated into the gameplay.

### Encounters

In a virtual world an encounter may be defined as a meeting between two or more virtual characters or may be thought of as a decision point at which a player encounters an opposing element (e.g. an enemy). An encounter may be player initiated (actively engaging in fighting an enemy) or unwanted by the player. A player may opt to avoid an encounter or may actively engage in them to move to the next level of the virtual world. The outcome of the encounters may at times define how the rest of the game progresses.

A random encounter is a feature commonly used in various role-playing games (RPGs) whereby an encounter with a non-player character (NPC), an enemy, a monster, or a dangerous situation occurs sporadically and at random. Random encounters are generally used to simulate the challenges associated with being in a hazardous environment, such as a monster-infested wilderness or dungeon usually with an uncertain frequency of occurrence to simulate a chaotic nature.

### Premise

The premise of a game or concept statement is a short, direct description of the situation of a game and describes the fundamental concept that drives the plot. The premise determines the primary goals of the virtual characters of a virtual world, the opposition to these goals and typically may define the means and the path that these virtual characters may take in achieving those goals. The primary objective is usually sought by both the protagonist (hero) and the antagonist (villain) but may only be achieved by one of them.

### Theme

A theme is the main idea, moral, or message, of a game. It is typically the common thread or oft repeated idea that is incorporated throughout a game. Examples of themes in games: espionage-themed role-playing game, martial arts—themed iPod based game, single-player horror-themed PC adventure game, fantasy-themed role-playing game, science fiction themed computer game, adult-themed video game, a horror-themed FPS (first person shooter) video game, futuristic-themed competitive fighting game, paranormal investigation-themed role-playing game etc.

### Settings

Settings in the virtual world control multiple areas of the virtual world (game). Settings may be changed by a player or may be impacted by the emotive state of a player.

### Levels

A level in the virtual world (video game) terminology refers to a discrete subdivision of the virtual world. Typically a players begins at the lowest level (level 1), and proceeds through increasingly numbered levels, usually of increasing difficulty, until they reach the top level to finish the game. In some games levels may refer to specific areas of a larger virtual world, while in other games it may refer to interconnected levels, representing different locations within the virtual world.

Thus in essence, the storyline may be changed by changing the plot nodes or set of plot nodes, virtual character (both player characters and non-player characters), set of virtual characters or virtual character interaction, settings, aesthetics, levels, premise or theme, encounters, levels etc. Thus a change in player emotive state may impact any one of the earlier mentioned items. The application is not limited to the cited examples, but the intent is to cover all such areas that may be used in a virtual world to impact the storyline of a virtual world.

Several exemplary embodiments/implementations of the invention of a changing storyline based on player emotive state are given below. There may be other methods obvious to the ones skilled in the art, and the intent is to cover all such scenarios.

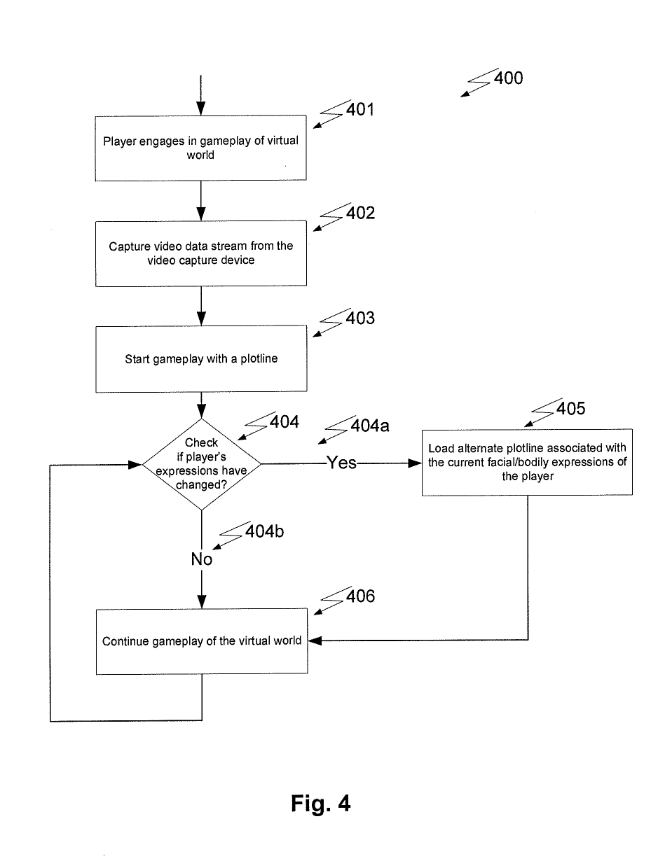

As shown in FIG. 4, the method may continue and changes may be tracked in the gameplay. While the player engages in gameplay of virtual world 401, video data stream may be captured from the video capture device 402. The gameplay that had started with a plotline 403 may be changed if the player's expressions (emotive state) have changed based on checkpoint 404. If no change 404b (i.e. the player's expressions and emotive state have not changed), then the gameplay of the virtual world simply continues 406. If there is a change 404a (i.e. the player's emotive state or expressions have changed), then the system may load an alternate plot associated with the current facial/body expressions of the player 405 and continue the gameplay of the virtual world 406.

The method may also be adapted for MMORPG. An MMORPG (Massively Multiplayer Online Role Playing Game) is a genre of role playing games where a very large number of players interact and engage in the gameplay of a virtual world. Such games include several common features for example a persistent game environment, some form of progression, social interaction within the game, in-game culture, membership in a group, and some level of virtual character customization to meet a player's need for a unique virtual character that suits their gaming style.

An alternate embodiment of the invention may be implemented in a console based multiplayer game.

In the MMORPG environment, a new player may engage in gameplay of the virtual world by for example logging into the MMORPG 501. The new player's emotive state is then gathered (e.g. using sensors built-in the gaming device 502). The system determines if the new player's emotive state is unique 503. The uniqueness of the emotive state of the new player can be determined by comparing it with the emotive state of the other players who are engaged in the game at that time. If it is not unique 503b (i.e. the player's expressions and emotive state are not unique), then the gameplay of the virtual world simply continues 505. If it is unique 503a (i.e. the new player's emotive state is unique and different from all other players engaged in the gameplay at that time), then the system may load an alternate/complementary set of storyline plot nodes which are associated with new player emotive state 504 and gameplay continues in the virtual world 505.

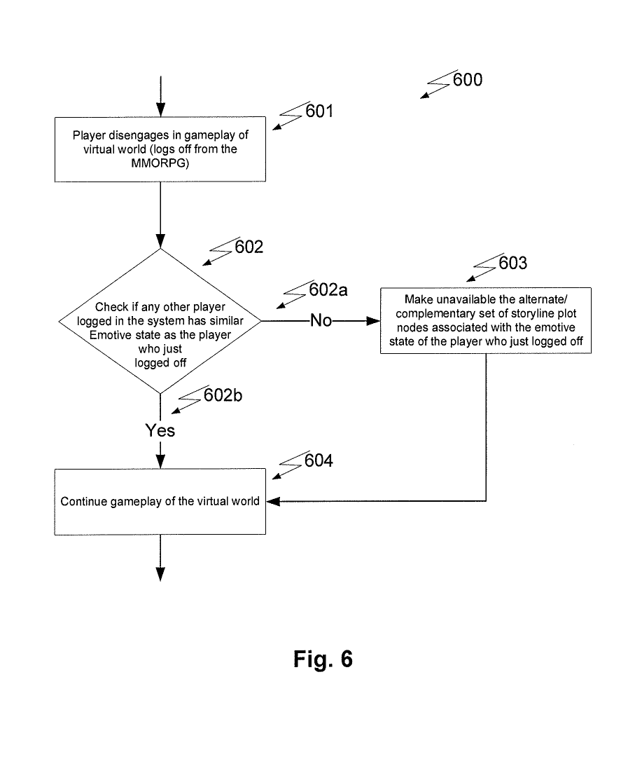

FIG. 6 traces the path if a player disengages in gameplay of MMORPG virtual world. When the player disengages or logs off from the MMORPG 601, the system checks to see if any other player engaged in the gameplay (i.e. still logged in the game) has a similar emotive state as the player who just logged off 602.

If Yes 602b (i.e. there is another player who has the same emotive state as the player who just logged off), then the gameplay of the virtual world simply continues 604.

If No 602a (i.e. there is no other player logged in the game who has the same expressions and emotive state as the player who just logged off), then the system may make unavailable the alternate/complementary set of storyline plot nodes associated with the emotive state of the player who just logged off 603 and continue the gameplay of the virtual world 604.

This is not limited to online games, but this process can also be adapted for a console based multiplayer game.

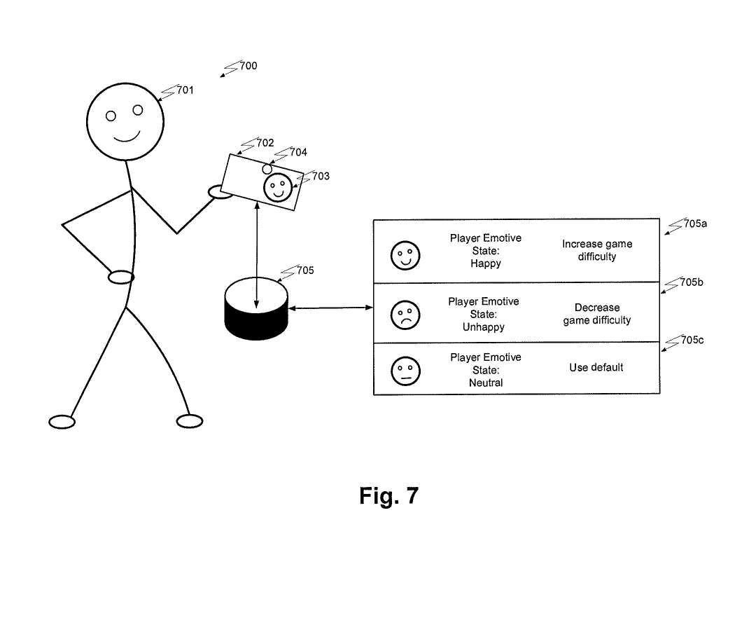

FIG. 7 shows a conceptual diagram of a simple embodiment of the invention, in this case using a mobile device. The mobile device 702 is used for playing the game. A sensor on the device (in this case, camera 704) captures the facial expression 701 of player 700. The photographic image of the facial expression is then compared in a database of facial expressions. The database 705 includes game instructions mapped to each facial expression 705a-705c. In this case, the “Happy” emotive state that was detected from the facial expression is mapped to an instruction for “Increase Game Difficulty” 705a. The result on the game on the mobile device may also be to show the character as having a “happy” facial expression (as shown) 703. If the expression had been undetectable or neutral, the mapping would have retrieved the instruction “Use Default” game difficulty 705c. If the expression had been unhappy or frustrated, the mapping would have retrieved the instruction “Decrease Game Difficulty” 705b.

In one embodiment of the invention, the method and system do not include the main gameplaying mechanism in determining the emotive state of the player. For example if it is a tilt game then do not use shake (i.e. the player shaking the device or controller) for determining the emotive state of the player. Similarly, if it is a game that uses the camera, then exclude the camera output from the sensors that are being used to determine the emotive state of the player. As another example if it is a touchscreen game, then exclude touch input from the inputs when determining the emotive state of the player.

In one embodiment of the invention the virtual character reflects the emotive state of the player. Thus if the player is happy the virtual character may smile and go about its adventure happily.

In one embodiment of the invention the virtual character, employing dramatic irony, does the opposite of what the player emotive state. Dramatic irony is when the words and actions of the characters of a work of literature have a different meaning for the reader than they do for the characters. This is the result of the reader having a greater knowledge than the characters themselves. Thus the virtual character may act or speak erroneously to heighten the drama.

In one embodiment of the invention the virtual character may employ pathetic fallacy or anthropomorphic fallacy. Pathetic fallacy or anthropomorphic fallacy is the treatment of inanimate objects as if they had human feelings, thought, or sensations. The word ‘pathetic’ in this context is related to ‘pathos’ or ‘empathy’ (capability of feeling). The endowment of nature to inanimate objects with human traits and feelings, as in the smiling skies; the angry sea; the weeping clouds illustrates this.

In one embodiment of the invention the health of the virtual character may also be directly or indirectly impacted by the player's emotive state e.g. in one embodiment of the invention if the player is happy and laughing then the health of the virtual character may improve and if the player is sad the health of the virtual character may degrade.

In one embodiment of the invention, a non-gaming application may also use the system and method disclosed in this application. For example an application for a mobile device like an iPhone or other similar device where a user may be performing some physical action, such as a demonstration or virtual performance where digital media may be intermixed with the presentation. The said mobile device may connect to a backend server using a network e.g. WiFi or wireless network of a service provider etc.

In another embodiment of the invention, the gaming device and the virtual world that may exist on it may incorporate the system and method of the invention. As the above examples illustrate, virtual worlds enabled by the disclosed invention allows for a merging of the physical and virtual worlds. This has implications for how users interact with the virtual world explicitly via controllers and implicitly via emotive states.

One embodiment of the invention may preferably also provide a framework or an API (Application Programming Interface) for virtual world creation that allows a developer to incorporate the functionality of capturing the player emotive state and using this to impact the storyline. Using such a framework or API allows for a more uniform virtual world generation, and eventually allows for more complex and extensive ability to interact with virtual objects.

It should be understood that although the term game has been used as an example in this application but in essence the term may also imply any other piece of software code where the embodiments of the invention are incorporated. The software application can be implemented in a standalone configuration or in combination with other software programs and is not limited to any particular operating system or programming paradigm described here. For the sake of simplicity, we singled out game applications for our examples. Similarly we described users of these applications as players. There is no intent to limit the disclosure to game applications or player applications. The terms players and users are considered synonymous and imply the same meaning. Likewise, virtual worlds, games and applications imply the same meaning. Thus, this application intends to cover all applications and user interactions described above and ones obvious to the ones skilled in the art.

Although interacting with virtual objects has been exemplified above with reference to gaming, it should be noted that virtual objects are also associated with many industries and applications. For example, virtual worlds/objects can be used in movies, cartoons, computer simulations, and video simulations, among others. All of these industries and applications would benefit from the disclosed invention.

The examples noted here are for illustrative purposes only and may be extended to other implementation embodiments. While several embodiments are described, there is no intent to limit the disclosure to the embodiment(s) disclosed herein. On the contrary, the intent is to cover all alternatives, modifications, and equivalents obvious to those familiar with the art.

1. A computer-implemented method of enabling virtual gameplay with a character on a computing device in communication with a storage means, the method comprising the steps of:
providing access to at least one video game in which a player is able to interact with the video game via a character;
detecting at the computing device the player's emotive state, and storing the player's emotive state on the storage means; and
in response to the detected emotive state, retrieving using the computing device a storyline for the character to interact with, the retrieved storyline being related to the emotive state of the player.

2. The method of claim 1, further comprising detecting a second or subsequent emotive state of the player in the course of gameplay, and retrieving a second or further storyline for the player's character to interact with, the second or further storyline being related to the second or subsequent emotive state.

3. The method of claim 1, wherein each storyline comprises one or a combination of plot, plot nodes, character interactions, encounters, settings, aesthetics, levels, premise, or theme.

4. The method of claim 2, wherein the second or further storyline replaces the previously retrieved storyline.

5. The method of claim 2, wherein the second or further storyline is added to the previously retrieved storyline.

6. The method of claim 1, further comprising modifying the character's appearance, facial or body expression or health in response to the detected emotive state.

7. The method of claim 1, further comprising modifying a level of difficulty in response to the detected emotive state.

8. The method of claim 7, wherein a detected happy or content emotive state results in an increased level of difficulty.

9. The method of claim 7, wherein a detected sad, angry or frustrated emotive state results in a decreased level of difficulty.

10. The method of claim 6, wherein the character is changed to match the player's emotive state.

11. The method of claim 6, wherein the character is changed to be the reverse of the player's emotive state.

12. The method of claim 1, wherein the scene or setting is modified to reflect the player's emotive state.

13. The method of claim 1, wherein game monsters, enemies, traps or puzzles are modified in response to the player's emotive state.

14. The method of claim 1, further comprising modifying character statistics of the character in response to the detected emotive state.

15. The method of claim 1, further comprising modifying tools, equipment or clothing of the character in response to the detected emotive state.

16. The method of claim 1, wherein the video game is accessible by multiple players and players having the same emotive state can interact in the game with each other via their characters.

17. The method of claim 1, wherein the video game is accessible by multiple players, each player having an emotive state, wherein a new player joining the game having a previously-unrepresented emotive state opens up a new storyline for all of the players currently in the game.

18. The method of claim 17, wherein if a player is the only player having a specific emotive state, the departure of that player from the game closes up a storyline for the remaining players in the game.

19. The method of claim 1, wherein the player's emotive state is re-detected at intervals, and in the event of a change in the player's emotive state, the character is shown moving to a new scene in the storyline.

20. The method of claim 1, wherein the detecting step further includes matching a player facial or body expression to facial and body expressions in a database of emotive states.

21. The method of claim 1, wherein the detecting step further includes matching a player sound or vocalization to sounds and vocalizations in a database of emotive states.

22. The method of claim 1, wherein the emotive state is detected at login.

23. The method of claim 1, wherein the emotive state is detected during gameplay.

24. The method of claim 1, wherein if a neutral emotive state is detected or the detected emotive state is an unsupported emotive state, a default storyline is provided.

25. The method of claim 1, wherein the storage means is provided by one or a combination of: a local fixed memory, a local removable memory, a remote fixed memory, a remote removable memory, and a virtual memory.

26. The method of claim 1, wherein the storage means is selected from the group consisting of: a local data storage of a game console, a local inbuilt memory, a user provided memory, an online server, and a shared folder on a network.

27. The method of claim 1, wherein the detecting step includes retrieving emotive state data from a sensor.

28. The method of claim 1, wherein the player is enabled to play the game using a game device, and the player's emotive state is detected by an on-board sensor on the game device.

29. The method of claim 28, wherein the game device is a mobile device.

30. The method of claim 27, wherein the sensor is one or a combination of camera, video camera, microphone, accelerometer, gyroscope, touch screen, temperature sensor, or pressure sensor.

31. The method of claim 1, wherein the detecting step includes obtaining emotive state information from player input.

32. The method of claim 1, wherein the player's emotive state is compared to emotive states in a database.

33. The method of claim 32, wherein the emotive states database is pre-populated.

34. The method of claim 32, wherein the emotive states database can be customized with player input.

35. The method of claim 30, wherein the sensor is a sensor that is not otherwise used as a game controller.

36. The method of claim 30, wherein any sensor used as a game controller is not used to receive player emotive state.
